(19) United States
(12) Patent Application Publication
(10) Pub. No.: US 2018/0297466 A1
(43) Pub. Date: Oct. 18, 2018

(54) ELECTRIC AND HYDRAULIC DRIVE SYSTEM AND METHODS

(71) Applicant: Autonomous Tractor Corporation, St. Michael, MN (US)

(72) Inventors: Terry Anderson, Brookings, SD (US); Robert S. Cornelius, St. Paul, MN (US)

(21) Appl. No.: 15/955,470

(22) Filed: Apr. 17, 2018

Related U.S. Application Data
(60) Provisional application No. 62/486,259, filed on Apr. 17, 2017.

(51) Int. Cl. B60K 6/46; B60K 6/26; B60T 13/12; B60T 15/04; B62D 5/12

(52) U.S. Cl. CPC B60K 6/46; B60K 6/26; F04C 2/08; B60T 15/04; B62D 5/12; B60T 13/12

(57) ABSTRACT

An electric propulsion system and methods are described that include an internal combustion engine coupled to a generator to provide power to one or more electric motors. Configurations are shown that include excitation control of power from the generator. Configurations are shown that include a hydraulic braking system. Configurations are shown that include an active suspension system.

### CLAIM OF PRIORITY

This application claims the benefit of priority under 35 U.S.C. § 119(e) to U.S. Provisional Patent Application No. 62/486,259, filed on Apr. 17, 2017, which is incorporated by reference herein in its entirety.

### TECHNICAL FIELD

Various embodiments described herein relate to apparatus, systems, and methods associated with vehicle propulsion, braking, suspension, and general operation.

### BACKGROUND

internal combustion engines have powered vehicles for several decades. However internal combustion power has a number of drawbacks, including pollutant byproducts from exhaust, and cost of operation. Electric propulsion systems remove the source of pollutant byproducts, however energy storage in batteries, etc. can be a technical challenge. Hybrid electric propulsions systems utilize an internal combustion engine that drives an electric generator. This configuration allows the internal combustion engine to operate at an efficient speed to improve fuel efficiency. Improved hybrid electric systems are desired.

### BRIEF DESCRIPTION OF THE DRAWINGS

FIG. 1 shows a block diagram of a hybrid electric propulsion system according to an embodiment of the invention.

FIG. 2 shows a block diagram of portion of a hybrid electric propulsion system with a braking system according to an embodiment of the invention.

FIG. 3 shows a block diagram of a hybrid electric propulsion system according to an embodiment of the invention.

FIG. 4 shows one example of a hybrid electric vehicle including a propulsion system according to an embodiment of the invention.

FIG. 5 shows a cross section of a suspension system incorporated into a hybrid electric propulsion system according to an embodiment of the invention.

### DETAILED DESCRIPTION

In the following detailed description of the invention, reference is made to the accompanying drawings that form a part hereof and in which are shown, by way of illustration, specific embodiments in which the invention may be practiced. These embodiments are described in sufficient detail to enable those skilled in the art to practice the invention. Other embodiments may be utilized and structural, logical, and electrical changes may be made.

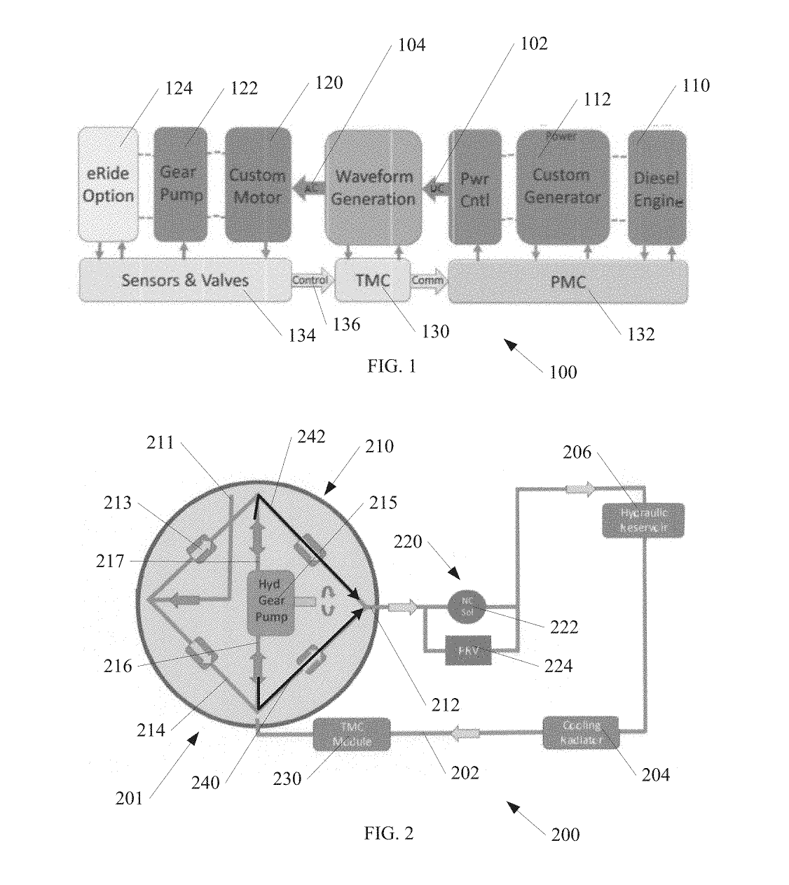

FIG. 1 shows a hybrid electric propulsion system 100 according to one example of the invention. The hybrid electric propulsion system 100 includes an internal combustion engine 110 coupled to a generator 112. In one example, the generator 112 is an AC power generator. In one example, the generator 112 is a three phase AC power generator.

The hybrid electric propulsion system 100 of FIG. 1 further shows a power controller 132. In one example, the power controller 132 is configured to convert AC power supplied from the generator 112 into DC power 102 to supply to other components in the system. In one example, the power controller 132 varies an amount of power by varying an excitation in the windings of the generator 112. In one example, in contrast to other forms of control such as voltage control or current control, varying excitation provides power control as a combination or varying both voltage and current at the same time. In one example, power control provides advantages, such as reducing undesired effects such as overheating of an electric motor during a high load operation, such as starting a vehicle from a dead stop.

The hybrid electric propulsion system 100 of FIG. 1 further shows at least one torque controller 130 coupled to a plurality of electric motors 120. In one example, the plurality of electric motors 120 include AC electric motors. In one example, the torque controller 130 is configured to convert DC power 102 from the generator 112 and power controller 132 into AC power 104 to supply to the electric motor 120. In one example, the torque controller 130 varies an amount of torque by varying a generated AC waveform to provide to the electric motors 120.

In one example, the propulsion system 100 includes a single electric motor 120 connected to one or more drive wheels or tracks using a transmission or other suitable mechanism. In one example, the propulsion system 100 includes multiple electric motors 120. In one example, the propulsion system 100 includes multiple electric motors 120 with an individual electric motor 120 coupled to drive each respective wheel. One advantage of a dedicated electric motor 120 for each drive wheel includes ease of repair. If a drive wheel is damaged, a modular assembly including a new drive wheel and associated electric motor 120 can be swapped into place to get the vehicle up and running while the damaged unit is repaired.

In one example, each wheel includes an encoder that provides physical feedback of wheel rotation positions for multiple wheels. In one example the encoder is an absolute encoder with physical indications of refined degrees of rotation. In one example, the encoder is a virtual encoder that determines an angular position based on a small number of position indicators and a timing circuit. In operation once a wheel passes a position indicator, a time until the wheel again passes the position indicator is measured. In subsequent revolutions, an angular position of the wheel can be estimated to a high degree of accuracy by measuring when the indicator is passed, in combination with how long the wheel has continued to rotate since the indicator was passed. One advantage of a virtual encoder is reduced cost. Another advantage of a virtual encoder is its small size that allows for use in compact machinery with little available space.

In one example feedback from encoders may be used by the torque controller 130 or torque controllers 130 to detect wheel slipping on one or more wheels. In one example, the torque controller 130 or torque controllers 130 may correct for wheel slippage by adjusting a frequency to an individual motor. In one example, the torque controller 130 or torque controllers 130 may correct for wheel slippage by adjusting the power to an individual motor.

FIG. 1 also shows a pump 122 and a suspension controller 124. In one example, each motor 120 includes a pump 122 and a suspension controller 124. FIG. 1 further illustrates one or more sensors and/or valves 134 that may be used by the pump 122 and suspension controller 124 for feedback 136 to the torque controller 130. Operation and control of the pump 122 and suspension controller 124 are described in more detail in examples below.

In one example, the generator 112 includes multiple windings that may be configured to work either in series or in parallel. In one example, the generator 112 includes two windings. In one example, the generator 112 may include three or more windings. In operation, the windings may be coupled in parallel for low speed, high power needs such as starting from a dead stop. In one example, the windings may be coupled in series for high speed needs such as normal driving on flat terrain. One of ordinary skill in the art, having the benefit of the present disclosure will recognize that a series configuration of two windings will provide 2× the voltage of a parallel configuration, and that a parallel configuration of two windings will provide 2× the amperage of a series configuration. More than two windings will provide additional combinations/options.

FIG. 2 shows an example of other aspects of a propulsion system 200 according to embodiments of the invention. Aspects of the propulsion system 100 from FIG. 1 may optionally be combined with aspects of propulsion system 200.

The propulsion system 200 includes a drive unit 210 such as an electric motor, and/or a wheel, or track system being driven by an electric motor. The drive unit 210 further includes a hydraulic pump 215 that is in turn connected to a reservoir 206 through hydraulic lines 202. In one example, a radiator 204 is further connected to the system 200. A torque controller 230 is further shown coupled to the propulsion system 200. In one example, the torque controller 230 is similar to the torque controller 130 from FIG. 1. As illustrated in FIG. 1, the torque controller 230 may receive feedback from the hydraulic pump 215, and act on the feedback provided.

One example of a hydraulic pump 215 includes a gear pump. Other examples such as vane pumps, etc. are also within the scope of the invention. In one example, the hydraulic pump 215 is coupled to the drive unit 210 such as a wheel, for example on a common drive shaft. Other mechanisms of coupling are also within the scope of the invention. In operation, the hydraulic pump 215 rotates and drives hydraulic fluid in response to motion by the wheel or other drive unit 210 on a vehicle.

In one example, flow controls 201 are provided to provide forward flow from the hydraulic pump 215 when the drive unit 210 operates in either a forward rotation or a backward rotation. A first inlet/outlet 216 is shown coupled to the hydraulic pump 215, and a second inlet/outlet 217 is also shown coupled to the hydraulic pump 215. In operation, if the drive unit 210 is rotating a forward direction then the first inlet/outlet 216 is operating as an outlet, and the second inlet/outlet 217 is operating as an inlet. Likewise, if the drive unit 210 is rotating a reverse direction then the first inlet/outlet 216 is operating as an inlet, and the second inlet/outlet 217 is operating as an outlet.

In the example of FIG. 2, the flow controls 201 include a plurality of check valves 213 coupled to the first inlet/outlet 216 and the second inlet/outlet 217 through hydraulic lines 214. Arrows on the check valves 213 indicate the allowed direction of flow through the check valves 213. In operation, if the first inlet/outlet 216 is operating as an outlet, then the check valves 213 drive flow of hydraulic fluid along arrow 240 to node 212. In operation, if the second inlet/outlet 217 is operating as an outlet, then the check valves 213 drive flow of hydraulic fluid along arrow 242 to node 212. While hydraulic fluid is being driven to node 212 by either forward rotation or reverse rotation, new fluid is being supplied into the system through supply line 211.

The example configuration of check valves and hydraulic lines of FIG. 2 illustrates one possible system that provides forward flow from the hydraulic pump 215 to the node 212 in either a forward rotation or a backward rotation. The illustrated configuration includes four check valves arranged as shown in FIG. 2. Other examples may use other numbers of check valves or other components apart from check valves, such as actuated valves, etc. in different configurations.

FIG. 2 further shows a braking system 220 coupled to the flow controls 201 from node 212. FIG. 2 shows a user operated brake valve 222. In one example, the user operated brake valve 222 may be opened, closed, or modulated to provide a selected level of constriction to flow from the node 212. In one example the control of a level of constriction provides a braking force that controls a speed of a vehicle using propulsion systems according to examples disclosed. In other examples the flow from the node 212 may be selectively used to provide power to a hydraulic cylinder to actuate a mechanical brake such as a disk and caliper or the like. Other mechanical braking configurations are also within the scope of the invention.

FIG. 2 further shows an emergency brake 224 according to examples of the invention. In one example, the user operated brake valve 222 may include a normally closed valve, that is held open using a powered control such as a solenoid. In the event of a power loss in a vehicle, it is desirable to be able to control braking, or to have brakes applied to stop a vehicle in an emergency loss of power. In one example, the emergency brake 224 is a pressure relief valve with an appropriate setting. If power to the user operated brake valve 222 is lost, then the valve reverts to normally closed, and diverts pressure through the emergency brake 224. An amount of resistance (pressure relief) may be selected to provide an appropriate stopping distance, without stopping too abruptly. An advantage to this configuration includes the ability to stop in the event of emergency power loss. Another advantage of this configuration is that due to the configuration of flow controls 201, there will always be a forward flow of fluid at node 212. In this way, both the user operated brake valve 222, and the emergency brake 224 will operate when the vehicle is travelling in a forward direction, or in a reverse direction.

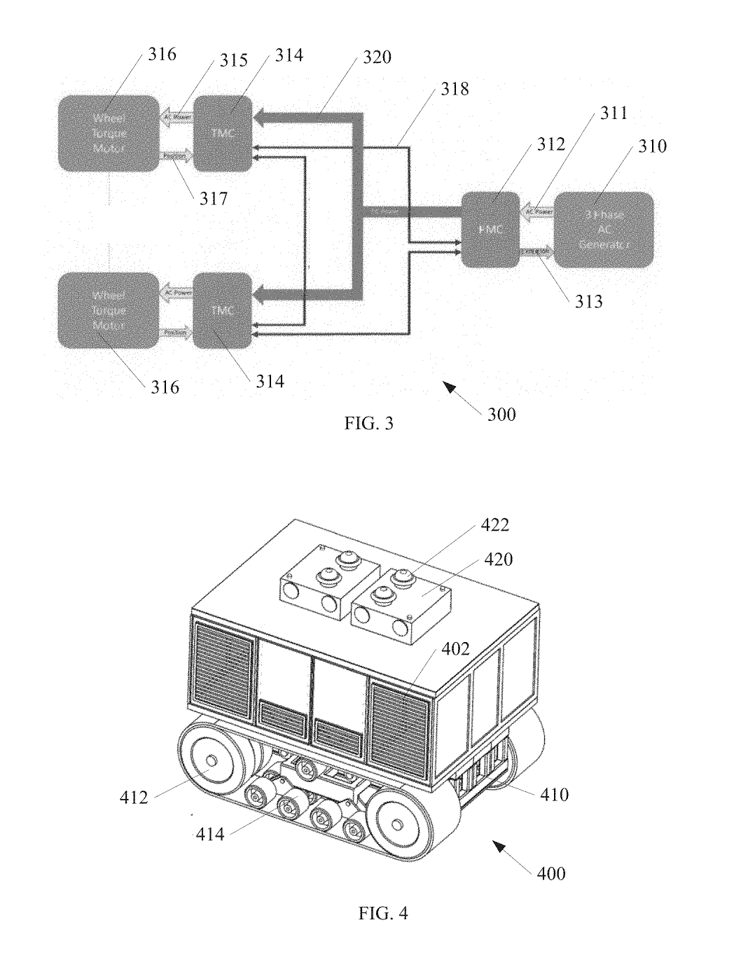

FIG. 3 shows an example of other aspects of a propulsion system 300 according to embodiments of the invention. Aspects of the propulsion system 100 from FIG. 1, and propulsion system 200 from FIG. 2 may optionally be combined with aspects of propulsion system 300.

In the example of FIG. 3, a plurality of drive motors 316 are shown, and each drive motor 316 has its own associated torque controller 314. As discussed in examples above, in one configuration, each torque controller 314 receives feedback from a component such as an encoder located on the drive motor 316. This information may then be used to vary an individual power supplied to each motor. The control signal from the torque controller 314 to the drive motor 316 is illustrated as command 315.

As illustrated in FIG. 1, in one example, AC power 311 is supplied from a generator 310, and is converted to DC power using a power controller 312. In one example, an amount of DC power 320 that is supplied to individual torque controllers 314 is controlled by varying excitation 313 in the windings of the generator 310. Feedback and control circuitry 318 is shown coupled between various components. In one example, the feedback and control circuitry 318 includes fiber optic cables, however the invention is not so limited. One advantage of fiber optical circuitry 318 includes high speed and bandwidth which results in more responsive control.

FIG. 4 shows an example vehicle 400 that may be used with embodiments of propulsion systems described above. In one example, the vehicle 400 is configured to operate as an agricultural vehicle, such as a tractor. The vehicle 400 includes a vehicle frame 410, and a diesel electric power supply 402 coupled to the vehicle frame 410. In one example, the diesel electric power supply 402. includes an internal combustion engine and generator similar to the internal combustion engine 110 and generator 112 from FIG. 1.

In the example shown, the vehicle 400 includes drive wheels 412 and a pair of track belts 414 running over the drive wheels 412. In one example, the drive wheels 412 each include an electric motor drive mounted substantially within a hub of the drive wheel 412 that is powered by the diesel electric power supply 302. In one example, all four drive wheels 412 include an electric motor.

In one example, the vehicle 400 includes multiple electric motors with an individual electric motor coupled to drive each respective drive wheel 412. One advantage of a dedicated electric motor for each drive wheel 412 includes ease of repair. If a drive wheel 412 is damaged, a modular assembly including a new drive wheel 412 and associated electric motor can be swapped into place to get the vehicle up and running while the damaged unit is repaired.

In one example, the vehicle 400 is an autonomous vehicle. In this example, the vehicle 400 of shows a mobile positioning system 420. A pair of lasers 422 are shown, as part of a laser positioning system. In one example, the mobile positioning system 420 further includes an RF positioning system located internal to the enclosure of mobile positioning system 420.

Although an autonomous vehicle 400 is shown as an example other examples of vehicles that may include propulsion systems according to embodiments described include standard tractors, cars, trucks, earth moving machinery, rail vehicles, etc. In one example, a propulsion system as described in embodiments above may be sold as a retrofit kit that is used to adapt a standard internal combustion engine system into a hybrid electric system.

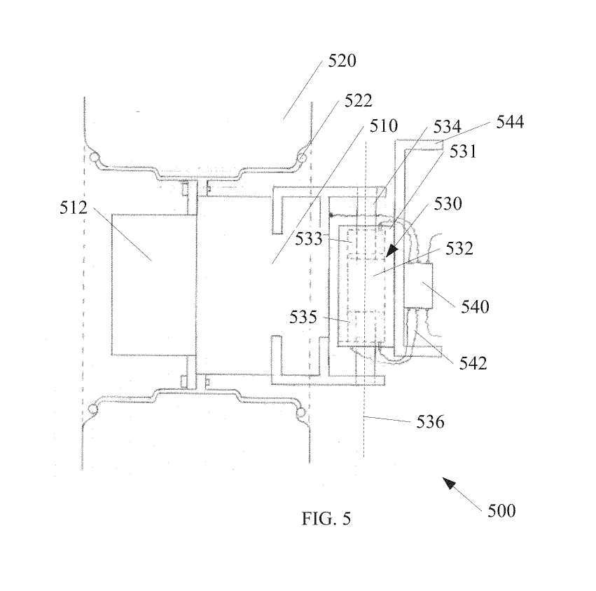

FIG. 5 shows an example of other aspects of a propulsion system 500 according to embodiments of the invention. Aspects of the propulsion system 100 from FIG. 1, propulsion system 200 from FIG. 2, and propulsion system 300 from FIG. 3 may optionally be combined with aspects of propulsion system 500.

FIG. 5 shows a tire or wheel 520 coupled to a motor 510. In the example shown, a gearbox 512 is further coupled to the motor 510 and the wheel 520 to provide a gear reduction. A hydraulic cylinder 530 is shown coupled to the motor 510 to provide a suspension function to the wheel 520. In the example shown, the hydraulic cylinder 530 includes a piston 532 with a shaft 534 coupled to the piston 532. The shaft 534 extends above and below a cylinder housing 531. A controller 540 is shown coupled to the hydraulic cylinder 530 through hydraulic lines 542, and is used to control a hydraulic pressure in both an upper chamber 533 and a lower chamber 535. By controlling pressure in the upper chamber 533 and the lower chamber 535, a height of the drive wheel is controlled.

In one example, the suspension function of the hydraulic cylinder 530 is an active suspension. Feedback from a linear encoder or from pressure sensors in the hydraulic cylinder 530 may be used to determine a state of the hydraulic cylinder 530, and the controller 540 actively uses the feedback information to adjust pressures in the upper chamber 533 and the lower chamber 535. This in turn adjusts a height of the wheel 520. Active suspensions are more controllable and adaptable to different conditions than passive suspensions such as conventional springs that are not able to be tuned or changed.

In the configuration of FIG. 5, the hydraulic cylinder 530 also provides a rotation axis 536 that controls steering of the wheel 520 with respect to the vehicle main frame 544. Advantages of such a configuration include simplicity of operation, requiting only a single hydraulic cylinder 530 per wheel 520. Further, active suspension can be used to smooth rolling of a vehicle, as well as changing a height of the vehicle by actively adjusting the hydraulic cylinders 530 on all wheels 520.

To better illustrate the method and apparatuses disclosed herein, a non-limiting list of embodiments is provided here:

Example 1 includes an electric propulsion system. The system includes an internal combustion engine, coupled to drive an AC generator, and a. power controller to convert AC power supplied by the AC generator into DC power. The system also includes at least one torque controller coupled to a plurality of AC electric motors, wherein the torque controller is configured to convert DC power from the power controller into AC power to supply to the plurality of AC electric motors.

Example 2 includes the electric propulsion system of example 1 wherein the power controller varies excitation in the generator to control power output.

Example 3 includes the electric propulsion system of any one of examples 1-2, wherein a speed of each of the plurality of AC electric motors is monitored using an encoder.

Example 4 includes the electric propulsion system of any one of examples 1-3, wherein each AC electric motor is paired to a corresponding torque controller.

Example 5 includes the electric propulsion system of any one of examples 1-4, wherein each AC electric motor is configured to vary an individual power provided by the torque controller paired to each AC electric motor.

Example 6 includes an electric propulsion system. The system includes an internal combustion engine, coupled to drive a generator, a plurality of AC electric motors coupled to the generator through a power controller, a hydraulic pump coupled to at least one of the plurality of AC electric motors, and flow controls configured to provide forward flow from the pump when the at least one AC electric motor operates in either a forward rotation or a backward rotation.

Example 7 includes the electric propulsion system of example 6 wherein the flow controls includes four check valves.

Example 8 includes the electric propulsion system of any one of examples 6-7, further including a braking system coupled to the flow controls, wherein regulation of the forward flow provides braking force to the at least one AC electric motor.

Example 9 includes the electric propulsion system of any one of examples 6-8, further including an emergency brake relief valve having a relief pressure setting that provides a braking force in the event of loss of power.

Example 10 includes the electric propulsion system of any one of examples 6-9, further including a user operated brake valve configured to modulate braking by controlling an amount of restriction to the forward flow.

Example 11 includes an electric propulsion system. The system includes an internal combustion engine, coupled to drive a generator, a plurality of electric motors, each electric motor coupled to a drive wheel, a hydraulic gear pump coupled to at least one of the plurality of electric motors, flow controls configured to provide forward flow from the pump when the at least one electric motor operates in either a forward rotation or a backward rotation, and a hydraulic cylinder coupled to one or more of the drive wheels, wherein rotation about a cylinder axis controls steering of the drive wheel, and wherein actuation of the hydraulic cylinder controls a height of the drive wheel.

Example 12 includes the electric propulsion system of example 11 wherein the plurality of electric motors includes a plurality of AC electric motors.

Example 13 includes the electric propulsion system of any one of examples 11-12, wherein the hydraulic cylinder includes a piston that passes through the cylinder and extends above and below a cylinder housing.

Example 14 includes the electric propulsion system of any one of examples 11-13, wherein a location of the cylinder housing within a range of motion along the piston is controlled by a hydraulic pressure feedback loop.

Example 15 includes the electric propulsion system of any one of examples 11-14, further including a braking system coupled to the flow controls, wherein regulation of the forward flow provides braking force to the at least one AC electric motor.

Example 16 includes the electric propulsion system of any one of examples 11-15, further including an emergency brake relief valve having a relief pressure setting that provides a braking force in the event of loss of power.

Example 17 includes the electric propulsion system of any one of examples 11-16, further including a user operated brake valve configured to modulate braking by controlling an amount of restriction to the forward flow.

These and other examples and features of the present systems, devices and methods are set forth in part in the above detailed description. This overview is intended to provide non-limiting examples of the present subject matter—it is not intended to provide an exclusive or exhaustive explanation.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated, In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed. Description, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. An electric propulsion system, comprising:
an internal combustion engine, coupled to drive an AC generator;
a power controller to convert AC power supplied by the AC generator into DC power;
at least one torque controller coupled to a plurality of AC electric motors, wherein the torque controller is configured to convert DC power from the power controller into AC power to supply to the plurality of AC electric motors.

2. The electric propulsion system of claim 1, wherein the power controller varies excitation in the generator to control power output.

3. The electric propulsion system of claim 1, wherein a speed of each of the plurality of AC electric motors is monitored using an encoder.

4. The electric propulsion system of claim 1, wherein each AC electric motor is paired to a corresponding torque controller.

5. The electric propulsion system of claim 1, wherein each AC electric motor is configured to vary an individual power provided by the torque controller paired to each AC electric motor.

6. An electric propulsion system, comprising:
an internal combustion engine, coupled to drive a generator;
a plurality of AC electric motors coupled to the generator through a power controller;
a hydraulic pump coupled to at least one of the plurality of AC electric motors; and
flow controls configured to provide forward flow from the pump when the at least one AC electric motor operates in either a forward rotation or a backward rotation.

7. The electric propulsion system of claim 6, wherein the flow controls includes four check valves.

8. The electric propulsion system of claim 6, further including a braking system coupled to the flow controls, wherein regulation of the forward flow provides braking force to the at least one AC electric motor.

9. The electric propulsion system of claim 8, further including an emergency brake relief valve having a relief pressure setting that provides a braking force in the event of loss of power.

10. The electric propulsion system of claim 8, further including a user operated brake valve configured to modulate braking by controlling an amount of restriction to the forward flow.

11. An electric propulsion system, comprising:
an internal combustion engine, coupled to drive a generator;
a plurality of electric motors, each electric motor coupled to a drive wheel;
a hydraulic gear pump coupled to at least one of the plurality of electric motors;
flow controls configured to provide forward flow from the pump when the at least one electric motor operates in either a forward rotation or a backward rotation; and
a hydraulic cylinder coupled to one or more of the drive wheels, wherein rotation about a cylinder axis controls steering of the drive wheel, and wherein actuation of the hydraulic cylinder controls a height of the drive wheel,

12. The electric propulsion system of claim 11, wherein the plurality of electric motors includes a plurality of AC electric motors.

13. The electric propulsion system of claim 11, wherein the hydraulic cylinder includes a piston that passes through the cylinder and extends above and below a cylinder housing.

14. The electric propulsion system of claim 13, wherein a location of the cylinder housing within a range of motion along the piston is controlled by a hydraulic pressure feedback loop.

15. The electric propulsion system of claim 11, further including a braking system coupled to the flow controls, wherein regulation of the forward flow provides braking force to the at least one AC electric motor.

16. The electric propulsion system of claim 15, further including an emergency brake relief valve having a relief pressure setting that provides a braking force in the event of loss of power.

17. The electric propulsion system of claim 16, further including a user operated brake valve configured to modulate braking by controlling an amount of restriction to the forward flow.
